(19) United States
(12) Patent Application Publication
(10) Pub. No.: US 2023/0039397 A1
(43) Pub. Date: Feb. 9, 2023

(54) USING ARTIFICIAL INTELLIGENCE TO OPTIMIZE SEAM PLACEMENT ON 3D MODELS

(71) Applicant: INTERNATIONAL BUSINESS MACHINES CORPORATION, ARMONK, NY (US)

(72) Inventors: Cindy Han Lu, San Jose, CA (US); Weiwei Liu, Irvine, CA (US); Thai Quoc Tran, San Jose, CA (US); Angela Monique LLOYD, Austin, TX (US)

(21) Appl. No.: 17/444,418

(22) Filed: Aug. 4, 2021

(51) Int. Cl. G06N 20/00; G06F 30/10

(52) U.S. Cl. CPC G06N 20/00; G06F 30/10

(57) ABSTRACT

A method, computer system, and a computer program product for determining locations for seams on a 3D model of an object is provided. The present invention may include training an artificial intelligence model using a set of training data. The present invention may include generating a first model for the object using a shrink wrap method. The present invention may include generating a second model for the object using a decimation method. The present invention may include comparing the object to objects in the set of training data to identify an object in the training data having a similar shape. The present invention may include identifying the object by determining if the object fits in between the first and second models. The present invention may lastly include projecting seams onto a model of the object using the trained artificial intelligence model.

### BACKGROUND

The present invention relates generally to the field of computing, and more particularly to UV maps.

UV unwrapping may be a process by which a three-dimensional (i.e., 3D) object may be deconstructed into a set of two-dimensional (2D) maps (e.g., vertex maps). This process may involve at least one correction from a human artist, including but not limited to seaming and/or manual UV coordinate placement.

### SUMMARY

Embodiments of the present invention disclose a method, computer system, and a computer program product for determining locations for seams on a 3D model of an object. The present invention may include training an artificial intelligence model using a set of training data. The present invention may include generating a first model for the object using a shrink wrap method. The present invention may include generating a second model for the object using a decimation method. The present invention may include comparing the object to objects in the set of training data to identify an object in the training data having a similar shape. The present invention may include identifying the object by determining if the object fits in between the first and second models. The present invention may lastly include projecting seams onto a model of the object using the trained artificial intelligence model.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for determining locations for seams on a 3D model of an object according to at least one embodiment;

FIG. 3 is an exemplary illustration of analyses performed by the seam placement program according to at least one embodiment;

FIG. 4 is a block diagram of internal and external components of computers and servers depicted in FIG. 1 according to at least one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for determining locations for seams on a 3D model of an object. As such, the present embodiment has the capacity to improve the technical field of 3D modeling by quickly identifying an object using a combination of both a shrink wrap method and a decimation method and by automating a placement of seams on the identified objects. More specifically, the present invention may include training an artificial intelligence model using a set of training data. The present invention may include generating a first model for the object using a shrink wrap method. The present invention may include generating a second model for the object using a decimation method. The present invention may include comparing the object to objects in the set of training data to identify an object in the training data having a similar shape. The present invention may include identifying the object by determining if the object fits in between the first and second models. The present invention may lastly include projecting seams onto a model of the object using the trained artificial intelligence model.

As described previously, UV unwrapping may be a process by which a three-dimensional (i.e., 3D) object may be deconstructed into a set of two-dimensional (2D) maps (e.g., vertex maps). This process may involve at least one correction from a human artist, including but not limited to seaming and/or manual UV coordinate placement. The human artist's (i.e., a user's) contribution may be both time consuming and tedious. However, both the UV unwrapping process and the user's experience may be improved upon through the use of artificial intelligence (AI) (e.g., by determining UV maps from a 3D model using AI).

Therefore, it may be advantageous to, among other things, use an AI engine to discover an optimal placement for edges and/or seams on a three-dimensional (i.e., 3D) object which may be used as the seams for the UV unwrapping process. An AI engine may follow at least one rule and may rely on a repository of previous seams for training purposes. Additionally, simulations may be performed by the AI engine to discover new edges which may be used as seams for the UV unwrapping process.

According to at least one embodiment, the present invention may automate the UV unwrapping process. This may include automating the steps of creating a three-dimensional (i.e., 3D) model and marking seams on the 3D model, using at least one of a plurality of UV unwrapping projection algorithms on the 3D model, making adjustments to the UV map as needed, and repeating the process until a desired outcome may be achieved.

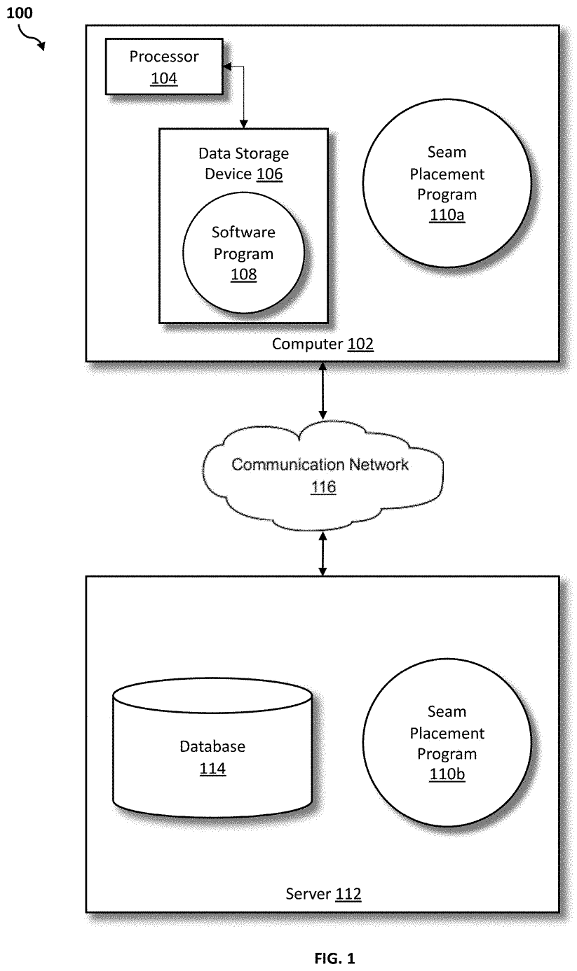

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a seam placement program 110a. The networked computer environment 100 may also include a server 112 that is enabled to run a seam placement program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

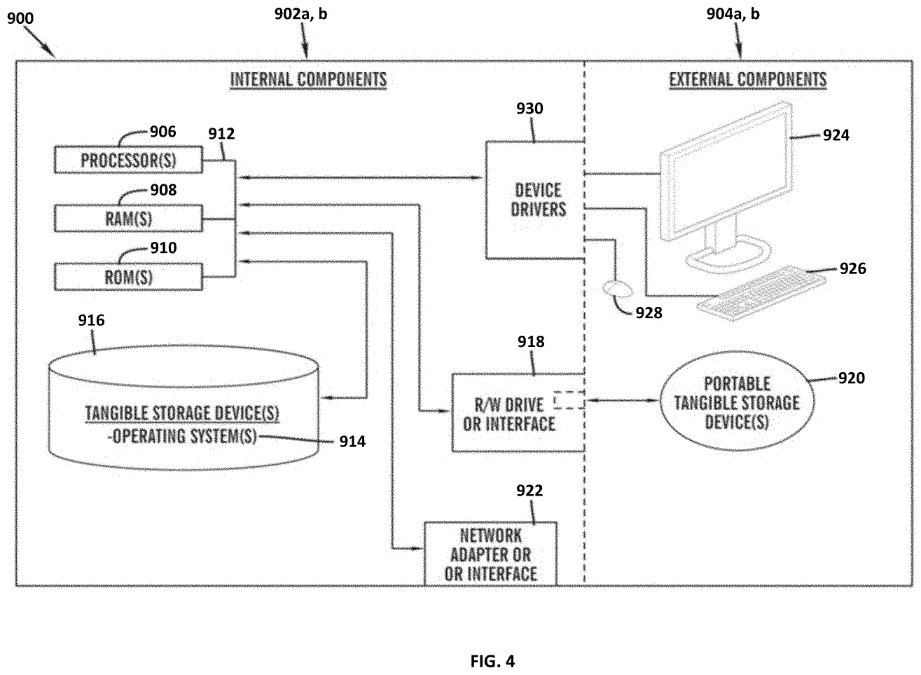

The client computer 102 may communicate with the server computer 112 via the communications network 116. The communications network 116 may include connections, such as wire, wireless communication links, or fiber optic cables. As will be discussed with reference to FIG. 4, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the seam placement program 110a, 110b may interact with a database 114 that may be embedded in various storage devices, such as, but not limited to a computer/mobile device 102, a networked server 112, or a cloud storage service.

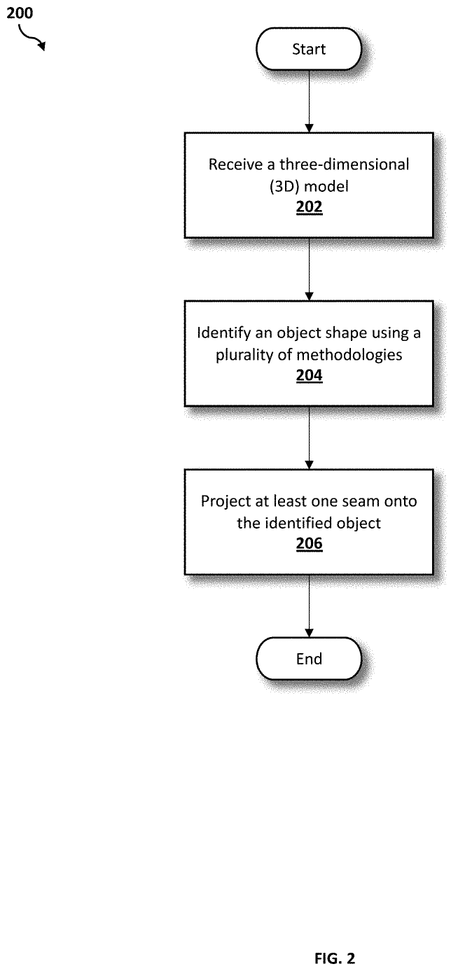

According to the present embodiment, a user using a client computer 102 or a server computer 112 may use the seam placement program 110a, 110b (respectively) to quickly identify an object using a combination of both a shrink wrap method and a decimation method and by automating a placement of seams on the identified objects. The seam placement method is explained in more detail below with respect to FIG. 2.

Referring now to FIG. 2, an operational flowchart illustrating the exemplary seam placement process 200 used by the seam placement program 110a and 110b according to at least one embodiment is depicted.

At 202, a three-dimensional (i.e., 3D) model is received. The seam placement program 110a, 110b may be fed at least one 3D model (e.g., as is depicted by 302 below) which has been UV mapped by human artists. UV mapping may be a three-dimensional modeling process of projecting a two-dimensional image onto the surface of a three-dimensional model to give the two-dimensional image color and/or texture. The “U” and the “V” of “UV” may refer to the horizontal and vertical axes, respectively, of the two-dimensional space, as X, Y, and Z may already be used in a three-dimensional space.

A mesh (e.g., a polygon mesh) may be a structural build of the three-dimensional (i.e., 3D) model consisting of polygons (e.g., straight-sided shapes defined by three-dimensional points called vertices and the straight lines that connect them called edges). A mesh may be a collection of vertices, edges, and faces that may define the shape of a three-dimensional object. For example, a single face may have, at a minimum, three vertices (e.g., for a triangular shape).

During an unwrapping of a three-dimensional (i.e., 3D) model, each face of the mesh may be cut along defined edges. A software application used for the 3D modeling may know, at least for primitive shapes, where the edges are. For more complex shapes, the software application used for 3D modeling may not accurately cut the mesh into faces. A user may, additionally and/or alternatively, mark seams on the 3D model to identify for the software application where the mesh should be cut. In instances where the user marks seams on the 3D model, the software application may cut along the lines defined by the user.

The seam placement program 110a, 110b may store both the mesh data (e.g., as a series of vertices) and a location of the seams of the received three-dimensional (i.e., 3D) model in a connected database (e.g., database 114).

At 204, an object's shape is identified using a plurality of methodologies. The plurality of methodologies used to identify the object shape may perform, but are not limited to performing, a shrink wrap analysis which may overestimate a volume of the mesh and/or a decimate analysis which may underestimate a volume of the mesh, among other analyses. Each of the shrink wrap and decimate analyses may be performed more than once on any object, each iteration which may result in different resolutions of the same object.

By both underestimating and overestimating the volume (and thereby, the shape) of a mesh, the seam placement program 110a, 110b may account for a margin of error. If an object “fits” between the space of the lower and upper limits of a previously identified object (e.g., the underestimated and overestimated volumes of the mesh) then the seam placement program 110a, 110b may identify a new object as being the same as the previously identified object (e.g., the identification of the object being a first step in determining where to place seams on the object).

The shrink wrap analysis (i.e., a shrink wrap method) may generate a first model of the object (e.g., as is depicted by 304 and 306 below) by caging the object in another primitive object (e.g., using a cube as the primitive object in which to cage the object being identified) and subdividing the surface of the cube into many smaller divisions, each with their own vertices. For example, each vertex may use ray casting and may project a ray inward until a surface of the mesh is reached. A location of the surface where the ray touches may be a new location of the vertex, and the process may be repeated for all vertices.

In a shrink wrap analysis, the seam placement program 110a, 110b may iteratively shrink wrap a received three-dimensional (i.e., 3D) model to determine at least one boundary of the mesh (e.g., the polygon mesh) and may create, within a software application used for 3D modeling, an object shape based on the determined boundary or boundaries. A user of the seam placement program 110a, 110b may specify a number of iterations to shrink wrap and/or decimate an object (e.g., to train the machine learning module). This may be a parameter of the seam placement program 110a, 110b which may be modified to achieve a desirable result. For example, the seam placement program 110a, 110b may default to three iterations of each a shrink wrap analysis and a decimate analysis and may determine that the resulting object identification and seam placement is only ninety percent accurate. Wanting to improve the accuracy with which the system operates, a user may change the number of iterations to four iterations of each analysis.

A shrink wrap analysis may take into consideration a number of polygons of a received 3D model and may identify an object shape based on using a lowest number of polygons of the object that still make the object identifiable as that object (e.g., using image processing and/or image recognition techniques). The shrink wrap analysis may be a projection algorithm which may, for example, determine a nearest surface point by projecting a ray into a center of the mesh to determine where the ray collides with the mesh. That location (e.g., the location in which the ray collides with the mesh) may be deemed the “nearest surface point.” This methodology of determining a shape of the received 3D model may not take into consideration surface changes of the mesh (e.g., the polygon mesh) and may use projection to determine an outer shape of the received 3D model. As a result, a shrink wrap analysis may generally overestimate a volume of the mesh (e.g., the polygon mesh).

The decimate analysis (i.e., a decimation method) may generate a second model of the object (e.g., as is depicted by 308 below) by slowly increasing an angle of detection and eliminating neighboring vertices which may be above the angle of detection. The angle of detection may be calculated using a mathematical formula for calculating an angle between two vectors, such as:

$$cos a = \frac{\overline{a} \cdot \overline{b}}{\vert \overline{a} \vert \cdot \vert \overline{b} \vert}$$

The decimate analysis may be repeated until all neighboring vertices may be below the angle of detection. Each iteration may reduce a polygon count even more and may reduce the mesh.

In a decimate analysis, the seam placement program 110a, 110b may iteratively decimate the received three-dimensional (i.e., 3D) model and may reduce the number polygons of an associated mesh. In order to determine whether the seam placement program 110a, 110b has decimated the 3D model too much, and whether an object of the 3D model is no longer recognizable, an image processing algorithm may be used to determine whether the decimated object of the 3D model is close enough to the original object of the 3D model. For example, this determination may be based on whether similarities of the decimated object of the 3D model and the original object of the 3D model are equal to or above a 90% threshold (e.g., a threshold which may be modifiable by a user of the seam placement program 110a, 110b). The seam placement program 110a, 110b may leverage a Similarity Search function of IBM Watson™ (Watson and all Watson-based trademarks are trademarks or registered trademarks of International Business Machines Corporation in the United States, and/or other countries) Visual Recognition service, among other similarity search functions, to perform an analysis as to similarity.

A decimate analysis may generally underestimate a volume of the mesh (e.g., of the polygon mesh) because of a reduction. This is because, as described previously, decimation refers to a process of reducing vertices while attempting to retain a shape. For example, if a polygon is a collection of interconnected vertices (e.g., where 3 vertices make a triangle and 4 vertices make a quad), then in theory, a 2×2 square that is laying on a flat surface may be represented as four small squares or as one large square. Decimation may be the process of reducing the four squares to one square while retaining an overall shape of the remaining vertices. On a three-dimensional (3D) model, surfaces may generally not be flat. This may mean that the more an object is decimated, the less likely an object's shape is to be retained because of a loss of vertices with each iteration.

The seam placement program 110a, 110b may store results of each methodology of determining the shape of an object of the received three-dimensional (i.e., 3D) model (e.g., including each level of decimation) in a connected database (e.g., database 114). This means that for each mesh object (i.e., object of the 3D model), two sets of data (e.g., one set which generally overestimates a volume of the mesh and one set which generally underestimates a volume of the mesh) may be stored in the connected database (e.g., database 114) and may be referenced by a trained machine learning module (i.e., an artificial intelligence model) of the seam placement program 110a, 110b when predicting the shape of a new mesh object. The machine learning module may be trained using a set of training data including 3D models (each 3D model being defined by x, y, z coordinates, of a plurality of different objects), each 3D model of the set being comprised of a plurality of 2D maps (each 2D map being defined by u, v coordinates) joined together at one or more seams. The seams of 3D models of the training data set may have been placed at locations on the 3D model which may have been deemed desirable by a human artist. The seams of 3D models which are not deemed desirable by a human artist (e.g., an incorrect prediction was made by the system) may be rejected by the human artist and the data may be used to retrain the machine learning module.

The machine learning module of the seam placement program 110a, 110b may compare results of each methodology of determining the shape of a new object to results stored in the connected database (e.g., database 114), starting from a lowest resolution (e.g., where a resolution is generated with each iteration of a shrink wrap and/or decimation analysis, and the more iterations with which an object is shrink wrapped/decimated, the lower a resolution becomes). If a match is not found, then the machine learning module of the seam placement program 110a, 110b may move on to a next resolution until a match is found (e.g., an object is identified) or until the machine learning module of the seam placement program 110a, 110b moves on to a next comparison. When a match is made, the seam placement program 110a, 110b may project seams from the matched shape (e.g., the matched shape is a shape from the training data set stored within the machine learning module of the seam placement program 110a, 110b or in a connected database thereof) onto the new object and may let a user make a final decision as to the placement of the seams. The automatically generated seams may be based on the identified shape of an object, and a user may accept or reject any automatically generated seams. If the user accepts the automatically generated seams, then the seam placement program 110a, 110b may associate the new shape with the same categorization of shape as the match which was used to generate the seams (e.g., based on a categorization of shapes stored within the machine learning module of the seam placement program 110a, 110b or a connected database thereof). As more results are submitted, the machine learning module of the seam placement program 110a, 110b may learn to quickly identify new 3D models and may correctly project seams onto them.

The seam placement program 110a, 110b may combine each of the plurality of methodologies of determining a shape of an object the received three-dimensional (i.e., 3D) model (e.g., by identifying a lower and an upper limit based on results of the plurality of methodologies) before making a prediction as to an identification of the object. By combining each of the methodologies, the seam placement program 110a, 110b may more accurately predict an object's shape.

When a new 3D model is received by the seam placement program 110a, 110b and an object of the 3D model is reduced to a basic shape, the seam placement program 110a, 110b may utilize previous results to identify the object of the 3D model. By utilizing previous results to identify the object of the 3D model, the seam placement program 110a, 110b may obtain a general idea of seam placement(s) which may, in fact, be accurate given the use of previous results. By utilizing previous results, the seam placement program 110a, 110b may improve both a time in which a human user may detect an optimal seam location, as well as an ability of a computer system (e.g., the seam placement program 110a, 110b) to determine an optimal seam location. Seam placement may be described in more detail with respect to step 206 below.

At 206, at least one seam is projected onto the identified object. Seam placement may be based on the determined object type, as described previously with respect to step 204 above. Seam placement may be performed in any manner utilized by the three-dimensional (i.e., 3D) modeling software.

Once seams are projected onto the identified object, same may be returned to the user, who may be prompted to either generate new seam vertices (e.g., a method which may project the seams onto the received mesh and create new vertices there) or to find nearest vertices (e.g., as determined by the three-dimensional (i.e., 3D) modeling software) which may be marked as seams (e.g., a method which may be less predictable as same is dependent on the location of vertices of the received mesh that the user wanted to seam, whether or not same are accurate and/or optimal).

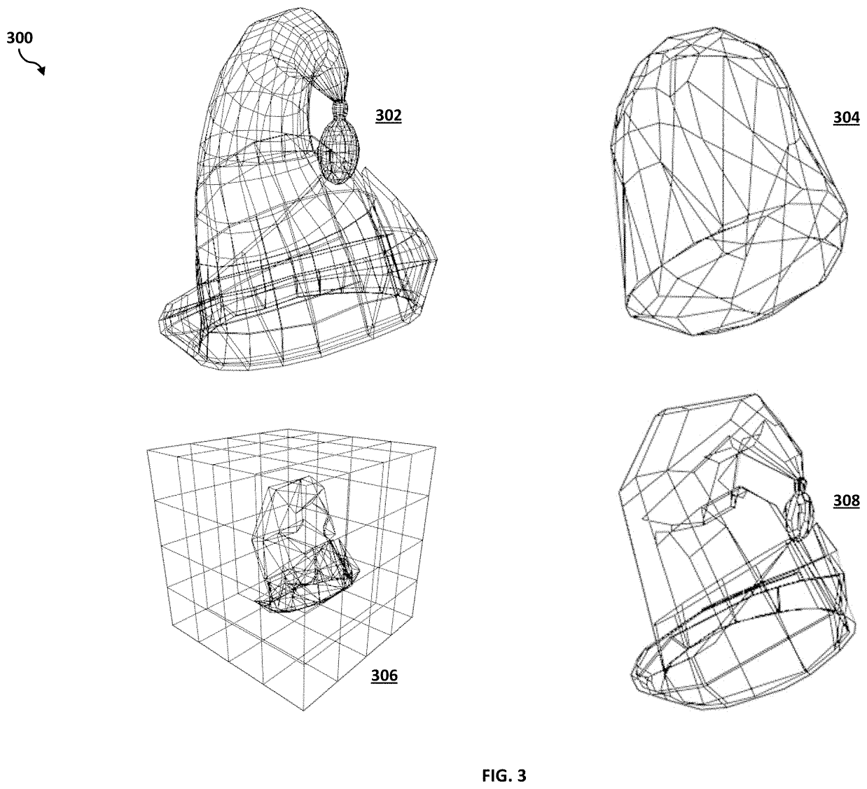

Referring now to FIG. 3, an exemplary illustration of analyses performed by the seam placement program according to at least one embodiment is depicted. As described previously with respect to step 204 above, a shape of an object 302 may be identified using a plurality of methodologies. One such methodology may be a shrink wrap analysis which may generate a first model of the object by caging the object in another primitive object (e.g., a cube), as is depicted by 304. A resulting shrink-wrapped object is depicted by 306. A second methodology may be a decimate analysis (i.e., decimation analysis) which may generate a second model of the object by reducing a number of polygons of an associated mesh of the three-dimensional (i.e., 3D) model. A result of the decimate analysis is depicted by 308.

It may be appreciated that FIGS. 2 and 3 provides only an illustration of one embodiment and do not imply any limitations with regard to how different embodiments may be implemented. Many modifications to the depicted embodiment(s) may be made based on design and implementation requirements.

FIG. 4 is a block diagram 900 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 4. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the seam placement program 110a in client computer 102, and the seam placement program 110b in network server 112, may be stored on one or more computer-readable tangible storage devices 916 for execution by one or more processors 906 via one or more RAMs 908 (which typically include cache memory). In the embodiment illustrated in FIG. 4, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the seam placement program 110a and 110b can be stored on one or more of the respective portable computer-readable tangible storage devices 920, read via the respective R/W drive or interface 918 and loaded into the respective hard drive 916.

Each set of internal components 902a, b may also include network adapters (or switch port cards) or interfaces 922 such as a TCP/IP adapter cards, wireless wi-fi interface cards, or 3G or 4G wireless interface cards or other wired or wireless communication links. The software program 108 and the seam placement program 110a in client computer 102 and the seam placement program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the seam placement program 110a in client computer 102 and the seam placement program 110b in network server computer 112 are loaded into the respective hard drive 916. The network may comprise copper wires, optical fibers, wireless transmission, routers, firewalls, switches, gateway computers and/or edge servers.

Each of the sets of external components 904a, b can include a computer display monitor 924, a keyboard 926, and a computer mouse 928. External components 904a, b can also include touch screens, virtual keyboards, touch pads, pointing devices, and other human interface devices. Each of the sets of internal components 902a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

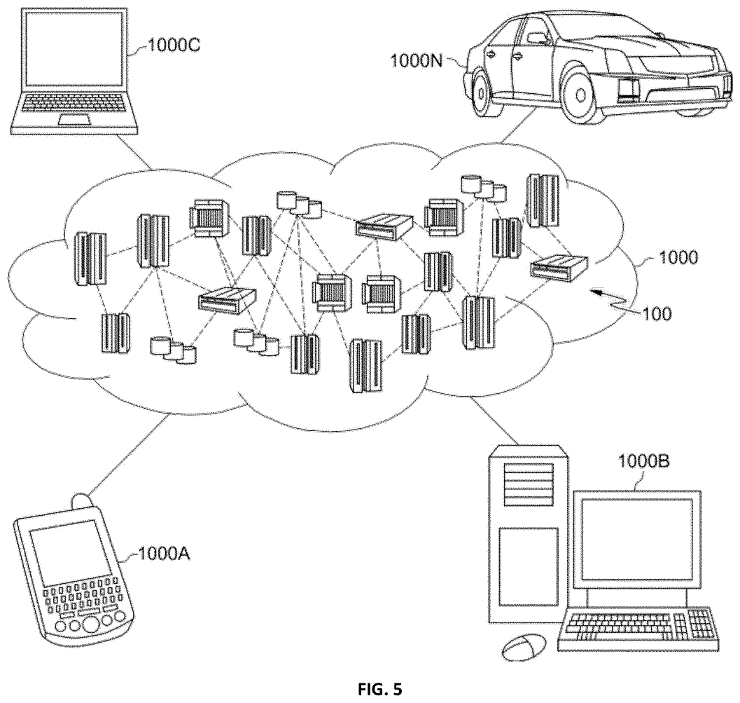

Referring now to FIG. 5, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 5 are intended to be illustrative only and that computing nodes 100 and cloud computing environment 1000 can communicate with any type of computerized device over any type of network and/or network addressable connection (e.g., using a web browser).

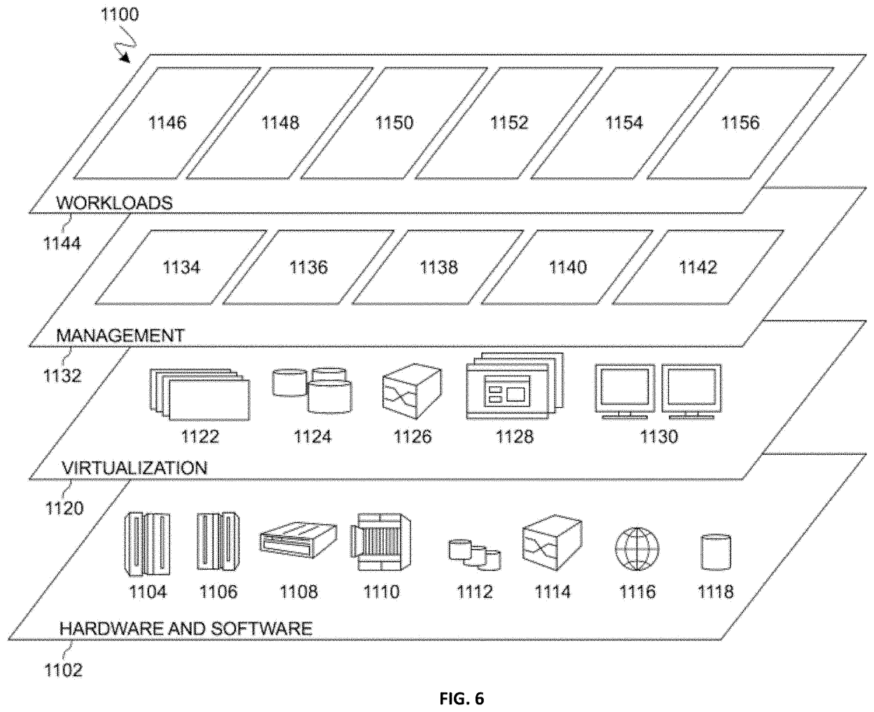

Referring now to FIG. 6, a set of functional abstraction layers 1100 provided by cloud computing environment 1000 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and seam placement 1156. A seam placement program 110a, 110b provides a way to quickly identify an object using a combination of both a shrink wrap method and a decimation method and by automating a placement of seams on the identified objects.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for determining locations for seams on a 3D model of an object, comprising:
training an artificial intelligence model using a set of training data, the training data including a set of 3D models (each 3D model being defined by x, y, z coordinates) of a plurality of different objects, each 3D model of the set being comprised of a plurality of 2D maps (each 2D map being defined by u, v coordinates) joined together at one or more seams, wherein the seams were placed at locations on the 3D model deemed desirable by an artist;
generating a first model for the object using a shrink wrap method, wherein the first model includes a plurality of polygons;
generating a second model for the object using a decimation method, wherein the second model includes a plurality of polygons;
comparing the object to objects in the set of training data to identify an object in the training data having a similar shape;
identifying the object by determining if the object fits in between the first and second models; and
projecting seams onto a model of the object using the trained artificial intelligence model.

2. The computer-implemented method of claim 1, further comprising prompting a user to generate new seam vertices.

3. The computer-implemented method of claim 1, further comprising finding nearest vertices and marking the nearest vertices as seams.

4. The computer-implemented method of claim 1, wherein the shrink wrap method overestimates a volume of the object.

5. The computer-implemented method of claim 1, wherein the decimation method underestimates a volume of the object.

6. The computer-implemented method of claim 1, further comprising:
determining a similarity of the second model to an image of the object using an image processing technique.

7. The computer-implemented method of claim 1, wherein identifying the object by determining if the object fits in between the first and second models further comprises:
determining a confidence metric for the identification.

8. A computer system for determining locations for seams on a 3D model of an object, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
training an artificial intelligence model using a set of training data, the training data including a set of 3D models (each 3D model being defined by x, y, z coordinates) of a plurality of different objects, each 3D model of the set being comprised of a plurality of 2D maps (each 2D map being defined by u, v coordinates) joined together at one or more seams, wherein the seams were placed at locations on the 3D model deemed desirable by an artist;
generating a first model for the object using a shrink wrap method, wherein the first model includes a plurality of polygons;
generating a second model for the object using a decimation method, wherein the second model includes a plurality of polygons;
comparing the object to objects in the set of training data to identify an object in the training data having a similar shape;
identifying the object by determining if the object fits in between the first and second models; and
projecting seams onto a model of the object using the trained artificial intelligence model.

9. The computer system of claim 8, further comprising prompting a user to generate new seam vertices.

10. The computer system of claim 8, further comprising finding nearest vertices and marking the nearest vertices as seams.

11. The computer system of claim 8, wherein the shrink wrap method overestimates a volume of the object.

12. The computer system of claim 8, wherein the decimation method underestimates a volume of the object.

13. The computer system of claim 8, further comprising:
determining a similarity of the second model to an image of the object using an image processing technique.

14. The computer system of claim 8, wherein identifying the object by determining if the object fits in between the first and second models further comprises:
determining a confidence metric for the identification.

15. A computer program product for determining locations for seams on a 3D model of an object, comprising:
one or more non-transitory computer-readable storage media and program instructions stored on at least one of the one or more tangible storage media, the program instructions executable by a processor to cause the processor to perform a method comprising:
training an artificial intelligence model using a set of training data, the training data including a set of 3D models (each 3D model being defined by x, y, z coordinates) of a plurality of different objects, each 3D model of the set being comprised of a plurality of 2D maps (each 2D map being defined by u, v coordinates) joined together at one or more seams, wherein the seams were placed at locations on the 3D model deemed desirable by an artist;
generating a first model for the object using a shrink wrap method, wherein the first model includes a plurality of polygons;
generating a second model for the object using a decimation method, wherein the second model includes a plurality of polygons;
comparing the object to objects in the set of training data to identify an object in the training data having a similar shape;
identifying the object by determining if the object fits in between the first and second models; and
projecting seams onto a model of the object using the trained artificial intelligence model.

16. The computer program product of claim 15, further comprising prompting a user to generate new seam vertices.

17. The computer program product of claim 15, further comprising finding nearest vertices and marking the nearest vertices as seams.

18. The computer program product of claim 15, wherein the shrink wrap method overestimates a volume of the object.

19. The computer program product of claim 15, wherein the decimation method underestimates a volume of the object.

20. The computer program product of claim 15, further comprising:
determining a similarity of the second model to an image of the object using an image processing technique.
